(19) United States
(12) Patent Application Publication
(10) Pub. No.: US 2018/0162176 A1
(43) Pub. Date: Jun. 14, 2018

(54) PNEUMATIC TIRE

(71) Applicant: TOYO TIRE & RUBBER CO., LTD., Itami-shi (JP)

(72) Inventor: Hiroyuki Haseda, Itami-shi (JP)

(73) Assignee: TOYO TIRE & RUBBER CO., LTD., Itami-shi (JP)

(21) Appl. No.: 15/800,344

(22) Filed: Nov. 1, 2017

(30) Foreign Application Priority Data
Dec. 14, 2016 (JP) 2016-242068

(51) Int. Cl. B60C 11/13

(52) U.S. Cl. CPC B60C 11/1353; B60C 2011/0348

(57) ABSTRACT

A pneumatic tire has a narrow groove extending in a tire circumferential direction. The narrow groove is formed in a shoulder land portion of a tread. An inside concave curved surface and an outside concave curved surface are formed in a groove bottom portion of the narrow groove. The inside concave curved surface is formed by depressing a groove wall in a tread center side. The outside concave curved surface is formed by depressing a groove wall in a tread end side. An inner surface of the groove bottom portion including the inside concave curved surface and the outside concave curved surface is formed by a single circular arc in a tire meridian cross section. A radius of curvature of the circular arc is equal to or larger than a width of an opening portion of the narrow groove.

### BACKGROUND OF THE INVENTION

### Field of the Invention

The present invention relates to a pneumatic tire in which a narrow groove extending in a tire circumferential direction is formed in a shoulder land portion of a tread.

### Description of the Related Art

Conventionally, there has been known a pneumatic tire in which a narrow groove extending in a tire circumferential direction is formed in a shoulder rib (an example of the shoulder land portion) of the tread, and the pneumatic tire is disclosed. The shoulder rib is sectioned into a main rib in a tread center side and a sacrificed rib in a tread end side by the narrow groove. In the tire structured as mentioned above, wear of the main rib can be suppressed by concentrating the wear on the sacrificed rib. As a result, it is possible to improve an irregular wear resistance. The narrow groove is also called as a defense groove, and is formed in a pneumatic tire for heavy load which is mainly used in a truck and a bus.

In this connection, in the case that the shoulder land portion is exposed to the great input by the tire running on stone curbs, the strain is locally concentrated to the groove bottom portion of the narrow groove and a crack may be generated. In correspondence thereto, patent documents 1 to 3 disclose a technique of suppressing the generation of the groove bottom crack by forming a cross section of the narrow groove into a round bottom flask shape. According to the technique, since the groove bottom portion of the narrow groove is wider than the opening portion and is formed into the rounded shape, the strain acting on the groove bottom portion tends to be dispersed, and a groove bottom crack resistance is improved.

However, even in the case that the narrow groove is formed into the round bottom flask shape, the strain can not be sufficiently dispersed when the size of the groove bottom portion becomes larger correspondingly. Further, since an inner surface of the groove bottom portion of the narrow groove is formed by connecting a plurality of circular arcs having different radii of curvature, there is fear that the strain is locally concentrated to a joint line of the circular arcs. In the light of the above, the inventor of the present invention has found room for further improvement concerning the groove bottom crack resistance. Since the groove bottom crack of the narrow groove may be a starting point of a so-called tear that a sacrificed rib is scattered so as to be torn, the improvement of the groove bottom crack resistance makes for improvement of a tear resistance.

Further, since the main rib may generate the local irregular wear even if the narrow groove is provided, there has been further room for improvement of the irregular wear resistance. As a result of search by the inventor of the present invention, there has been found that a ground pressure tends to become high in the tread end side edge of the main rib and the main rib generates the irregular wear due to the tendency. For example, in the patent document 2 (FIGS. 1 and 2) and the patent document 3 (FIG. 2), the groove bottom portion of the narrow groove is formed by depressing only one side groove wall which comes to a tread end side. In the structure mentioned above, it is thought that the local irregular wear caused by the ground contact pressure distribution of the main rib can not be suppressed.

### PRIOR ART DOCUMENT

### Patent Document

Patent Document 1: WO2008/111582

Patent Document 2: JP-A-2001-260612

Patent Document 3: JP-A-H03-7604

### SUMMARY OF THE INVENTION

The present invention is made by taking the above actual condition into consideration, and an object of the present invention is to provide a pneumatic tire in which a narrow groove extending in a tire circumferential direction is formed in a shoulder land portion of a tread, and which is excellent in a groove bottom crack resistance, a tear resistance and an irregular wear resistance.

The present invention provides a pneumatic tire comprising a narrow groove which extends in a tire circumferential direction, with the narrow groove being formed in a shoulder land portion of a tread, wherein an inside concave curved surface and an outside concave curved surface are formed in a groove bottom portion of the narrow groove, the inside concave curved surface being formed by depressing a groove wall in a tread center side, and the outside concave curved surface being formed by depressing a groove wall in a tread end side, wherein an inner surface of the groove bottom portion including the inside concave curved surface and the outside concave curved surface is formed by a single circular arc in a tire meridian cross section, and wherein a radius of curvature of the circular arc is equal to or larger than a width of an opening portion of the narrow groove.

According to the structure mentioned above, the groove bottom portion of the narrow groove is formed into a shape which is wider than the opening portion of the narrow groove and is rounded. Further, since the inner surface of the groove bottom portion of the narrow groove is formed by the single circular arc, the position to which the strain tends to be locally concentrated is not formed in the groove bottom portion. Further, since the radius of curvature of the circular arc mentioned above is equal to or larger than the width of the opening portion of the narrow groove, the size of the groove bottom portion is secured to be correspondingly large. As a result, it is possible to achieve an excellent groove bottom crack resistance by effectively dispersing the strain which is applied to the groove bottom portion of the narrow groove when the shoulder land portion is exposed to the great input.

As mentioned above, according to the tire, it is possible to well suppress the generation of the groove bottom crack in the narrow groove and it is further possible to suppress the generation of the tear starting point. Accordingly, the tire is excellent in the tear resistance. Further, since the inside concave curved surface formed by depressing the groove wall in the tread center side is formed in the groove bottom portion, it is possible to lower the ground contact pressure of the tread end side edge of the main rib, it is possible to suppress the local irregular wear in the main rib and it is possible to achieve the excellent irregular wear resistance.

In the light of appropriate enlargement of the size in the groove bottom portion of the narrow groove, the radius of curvature of the circular arc is preferably larger than the width of the opening portion of the narrow groove.

It is preferable that a center point of the circular arc is positioned closer to the tread center side than a width center position of the narrow groove. According to the structure mentioned above, the depression of the tread end side in the groove bottom portion of the narrow groove becomes small and the depression of the tread center side becomes large, in comparison with the case that the center point of the circular arc exists at the center position in the width direction of the narrow groove. As a result, it is possible to suppress the rigidity reduction of the sacrificed rib due to the outside concave curved surface, and it is possible to achieve the more excellent tear resistance. Further, it is possible to well lower the ground contact pressure of the tread end side edge of the main rib, it is possible to suppress the local irregular wear in the main rib and it is possible to achieve the more excellent wear resistance.

It is preferable that a distance from the center point of the circular arc to the width center position of the narrow groove is equal to or less than 0.5 times of the width of the opening portion of the narrow groove. As a result, since the portion connecting the inner surface of the groove bottom portion formed by the single circular arc and the groove wall in the tread center side is not angulated to an acute angle, the structure is advantageous for enhancing the groove bottom crack resistance.

It is preferable that a depth getting to the groove bottom portion from a surface of the tread is equal to or larger than a depth of a main groove facing the shoulder land portion. According to the structure mentioned above, the groove bottom portion of the narrow groove is not exposed to the surface until getting to the terminal end of the tread wear, and it is possible to well maintain the excellent groove bottom crack resistance.

### BRIEF DESCRIPTION OF THE DRAWINGS

FIG. 1 is a cross sectional view of a tire meridian schematically showing one example of a tread of a pneumatic tire according to the present invention;

FIG. 2 is an enlarged view showing a substantial part of FIG. 1; and

FIG. 3 is a tire meridian cross sectional view of a narrow groove in a pneumatic tire according to the other embodiment of the present invention.

### DETAILED DESCRIPTION OF THE PREFERRED EMBODIMENTS

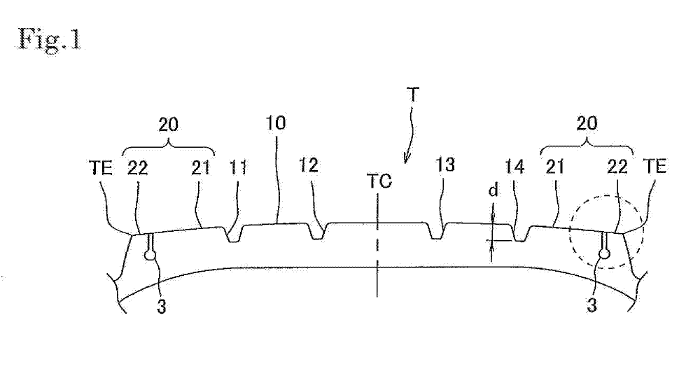

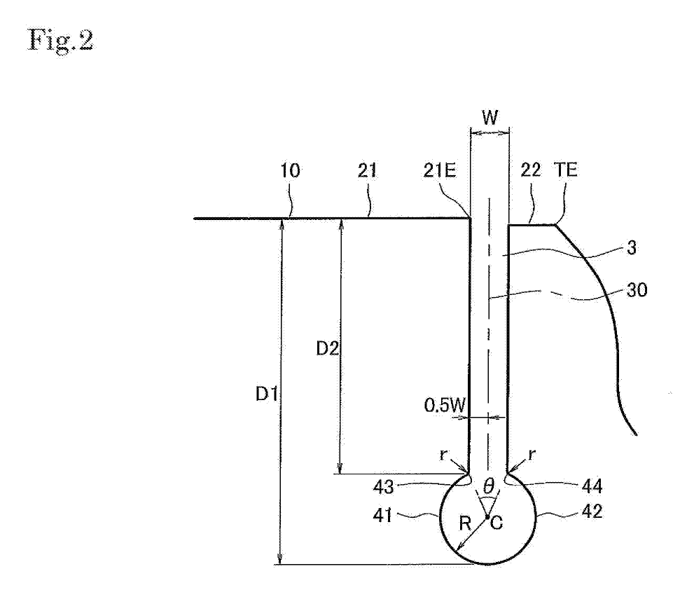

An embodiment of the present invention will be explained with reference to the drawings. FIG. 1 schematically shows a tread 10 of a pneumatic tire T according to the present embodiment. FIG. 2 shows a substantial part which is surrounded by a broken line frame in FIG. 1 in an enlarged manner.

The pneumatic tire T has a pair of beads (not shown) and a pair of side walls which extend to an outer side in a tire radial direction from the beads, in the same manner as the general pneumatic tire, and the tread 10 is provided in such a manner as to be connected to an outer end in the tire radial direction of each of the side walls. Further, a carcass extending like a toroidal shape is provided between a pair of beads, and a reinforcing member such as a belt reinforcing the carcass is buried in the tread 10, however, an illustration of them is omitted.

A plurality of main grooves extending in a tire circumferential direction are formed in the tread 10, and four main grooves 11 to 14 are formed in the present embodiment. The tread 10 is sectioned into a plurality of land portions including shoulder land portions 20 by a plurality of main grooves. The shoulder land portion 20 is positioned between each of tread ends TE and respective one of the shoulder main grooves 11 and 14 positioned in the outermost sides in the tire width direction. In the present embodiment, the shoulder land portion 20 is provided as a shoulder rib which continuously extends in the tire circumferential direction, however, is not limited to this.

In the tire T, the narrow groove 3 extending in the tire circumferential direction is formed in the shoulder land portion 20 of the tread 10. The narrow groove 3 extends continuously in a straight line shape or a zigzag shape along the tire circumferential direction. A depth D1 of the narrow groove 3 is, for example, in a range which is 0.3 to 1.5 times of a depth d of the shoulder main grooves 11 and 14. The narrow groove 3 is formed narrower than the shoulder main grooves 11 and 14 on a surface of the tread 10, and a width W of an opening portion of the narrow groove 3 is, for example, in a range between 0.3 and 5.0 mm. The narrow groove 3 may be provided only in the shoulder land portion 20 in one side, however, is preferably provided in the shoulder land portions 20 in both sides for achieving an excellent irregular wear resistance.

The shoulder land portion 20 is sectioned into a main rib 21 in a tread center TC side, and a sacrificed rib 22 in a tread end TE side by the narrow groove 3. The narrow groove 3 is positioned in the vicinity portion of the tread end TE of the shoulder land portion 20, and the main rib 21 is provided wider than the sacrificed rib 22. The narrow groove 3 is formed into a round bottom flask shape in a tire meridian cross section, and the groove bottom portion thereof is formed into a shape which is wider than the opening portion of the narrow groove 3 and is rounded.

As shown in FIG. 2 in an enlarged manner, an inside concave curved surface 41 and an outside concave curved surface 42 are formed in the groove bottom portion of the narrow groove 3, the inside concave curved surface 41 being obtained by depressing a groove wall in the tread center TC side, and the outside concave curved surface 42 being obtained by depressing a groove wall in the tread end TE side. The inside concave curved surface 41 is formed by a flection surface which is depressed to an inner side in a tire width direction and has a circular arc cross sectional shape, and the outside concave curved surface 42 is formed by a flection surface which is depressed to an outer side in the tire width direction and has a circular arc cross sectional shape. The inside concave curved surface 41 and the outside concave curved surface 42 are both extended annularly along the tire circumferential direction.

The groove bottom portion of the narrow groove 3 has an inner surface which is formed into a shape of an upward Landolt ring in the tire meridian cross section. The inner surface is constructed by connecting an inside concave curved surface 41, an outside concave curved surface 42 and a bottom surface of the narrow groove 3 which is sandwiched therebetween. In the narrow groove 3, an inner surface of the groove bottom portion including the inside concave curved surface 41 and the outside concave curved surface 42 is formed by a single circular arc in the tire meridian cross section. In FIG. 2, reference symbol R denotes a radius of curvature of the circular arc, and reference symbol C denotes a center point of the circular arc. The radius of curvature R of the circular arc is equal to or larger than a width W of the opening portion of the narrow groove 3, and the radius of curvature R and the width W satisfy the relationship R≥W.

In the tire T, the inner surface of the groove bottom portion of the narrow groove 3 is not formed by connecting a plurality of circular arcs, but is formed by the single circular arc as mentioned above. As a result, the position to which the strain tends to be locally concentrated is not formed in the groove bottom portion. Further, since the groove bottom portion of the narrow groove 3 is wider than the opening portion and the radius of curvature R thereof is equal to or larger than the width W, the size of the groove bottom portion is secured to be correspondingly large. As a result, it is possible to achieve an excellent groove bottom crack resistance by effectively dispersing the strain which is applied to the groove bottom portion of the narrow groove when the shoulder land portion is exposed to the great input.

As mentioned already, according to the tire T, it is possible to well suppress the generation of the groove bottom crack in the narrow groove 3. Since the groove bottom crack of the narrow groove 3 causes the tear by extending to the tread end TE side, suppressing the generation of the groove bottom crack which may come to the starting point of the tear contributes to improvement of the tear resistance. Further, since the inside concave curved surface 41 formed by depressing the groove wall of the tread center TC side is formed in the groove bottom portion, it is possible to lower the ground contact pressure of the tread end side edge 21E of the main rib 21, it is possible to suppress the local irregular wear in the main rib 21 and it is possible to achieve the excellent irregular wear resistance.

In the light of suitable enlargement of the size in the groove bottom portion of the narrow groove 3, it is preferable that the radius of curvature R is larger than the width W, that is, the relationship R>W is satisfied, and it is more preferable that the radius of curvature R is equal to or more than 1.2 times of the width W. Further, in order to prevent the size of the groove bottom portion from being larger than necessary, the radius of curvature R is preferably equal to or less than 2.0 times of the width W.

A corner portion 43 is a portion which connects the inner surface of the groove bottom portion formed by the single circular arc and the groove wall in the tread center TC side, and a corner portion 44 is a portion which connects the inner surface of the groove bottom portion and the groove wall in the tread end TE side. In order to enhance the groove bottom crack resistance, the corner portions 43 and 44 are preferably rounded via a circular arc having a radius of curvature r. In this case, the single circular arc having the radius of curvature R is arranged between a pair of circular arcs having the radius of curvature r. In order to secure a length of the circular arc having the radius of curvature R, the radius of curvature r is preferably smaller than the radius of curvature R. An angle θ formed by a pair of straight lines connecting both ends of the single circular arc and the center point C is, for example, between 40 and 80 degrees.

A depth D2 getting to the groove bottom portion from the surface of the tread 10 is preferably equal to or larger than a depth d of the main groove 14 which faces the shoulder land portion 20. As a result, the groove bottom portion of the narrow groove 3 is not exposed to the surface until getting to the wear end of the tread 10, and the excellent groove bottom crack resistance can be well maintained.

In FIG. 2, a width center position 30 of the narrow groove 3 is shown by a chain line. The chain line passes a width center of the opening portion of the narrow groove 3 in the tire meridian cross section, and extends to a direction which is along a normal line of the surface of the tread 10. In the present embodiment, there is shown an example in which the center point C of the circular arc exists at the width center position 30. Each of depths D1 and D2 is assumed to be measured on the width center position 30 (that is, along the chain line mentioned above) in a no-load state.

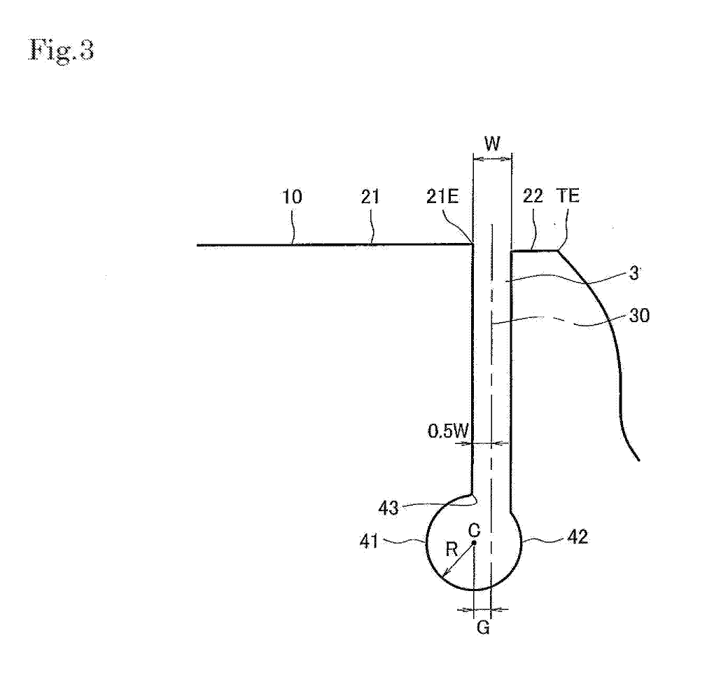

FIG. 3 shows a cross section of a narrow groove according to the other embodiment. Since the embodiment has the same structures as the embodiment shown in FIG. 2 except the below described structure, a description will be given mainly of different points while omitting common points. The same reference numerals are attached to the same positions as the positions described in the embodiment in FIG. 2, and an overlapping description will be omitted.

As shown in FIG. 3, in the present embodiment, the center point C of the circular arc forming the inner surface of the groove bottom portion is arranged closer to the tread center TC side than the width center position 30 of the narrow groove 3. As a result, the depression in the tread end TE side in the groove bottom portion of the narrow groove 3 becomes small and the depression in the tread center TC side becomes large in comparison with the embodiment mentioned above. As a result, the more excellent tear resistance can be achieved by suppressing the rigidity reduction of the sacrificed rib 22 caused by the outside concave curved surface 42. Further, it is possible to well lower the ground contact pressure of the tread end side edge 21E, it is possible to suppress the local irregular wear in the main rib 21 and it is possible to achieve the more excellent irregular wear resistance.

In order to achieve the effect mentioned above, a distance G from the center point C of the circular arc to the width center position 30 of the narrow groove 3 is preferably equal to or more than 0.1 times of the width W of the opening portion of the narrow groove 3, that is, preferably satisfies the relationship 0.1 W≤G. Further, the distance G is preferably equal to or less than 0.5 times of the width W, that is, preferably satisfies the relationship G≤0.5 W. As a result, since the corner portion 43 corresponding to the portion connecting the inner surface of the groove bottom portion formed by the single circular arc and the groove wall in the tread center TC side is not angulated to the acute angle, the structure is advantageous for enhancing the groove bottom crack resistance.

The pneumatic tire according to the present invention is the same as the normal pneumatic tire except the matter that the narrow groove is formed by the shoulder land portion of the tread as mentioned above, and the conventionally known materials, shapes and structures can be all employed in the present invention.

Since the pneumatic tire according to the present invention can achieve the excellent groove bottom crack resistance, tear resistance and irregular wear resistance on the basis of the actions and effects as mentioned above, the pneumatic tire can be useful for the pneumatic tire for heavy load which is used particularly to the truck and the bus.

The present invention is not limited to the embodiment mentioned above, but can be modified and changed variously within a range which does not deviate from the scope of the present invention. For example, the tread pattern can be appropriately changed in correspondence to the used intended purposes and conditions.

### EXAMPLES

An example which concretely shows the structure and effect of the present invention will be explained. An evaluation of each of performances is executed as follows.

(1) Irregular Wear Resistance

The tire was assembled in the wheel having the rim size 22.5×8.25, the pneumatic pressure was set to 760 kPa (TRA specified internal pressure), the traveling test was executed under the condition of the speed 80 km/h and the load 27.5 kN (IRA 100% load), and the irregular wear ratio of the tread was examined. The irregular wear ratio was calculated as a ratio (Sh/Ce) of a wear amount Sh of the shoulder land portion in relation to a wear amount Ce of the center land portion passing through the tread center. The closer to 1.00 the numerical value is, the more the irregular wear is suppressed, which indicates an excellent irregular wear resistance.

(2) Groove Bottom Crack Resistance

The tire was assembled in the wheel having the rim size 22.5×8.25, the pneumatic pressure was set to 760 kPa, the traveling test was executed by using a drum with cleat under the condition of the speed 60 km/h and the load 21.8 kN, and the width of the groove bottom crack in the narrow groove was measured after traveling for 15,000 km. The measured value was indexed on the assumption that the result of a comparative example 4 was set to 100. The smaller numerical value indicates that the generation of the groove bottom crack is more suppressed and the tire is more excellent in the groove bottom crack resistance. Since the groove bottom crack may be a starting point of the tear, the inferior groove bottom crack resistance can be evaluated as the inferior tear resistance.

### COMPARATIVE EXAMPLES AND WORKING EXAMPLES

Comparative examples 1 and 2 and working examples 1 to 4 were formed by differentiating the radius of curvature R and the distance G mentioned above, in a tire (size: 295/75R22.5) having a tread which is sectioned into five land portions by four main grooves. The other structures of the narrow groove than these sizes and the other structures of the tire than the narrow groove are common in each of the examples, and the width W of the opening portion of the narrow groove was uniformly set to 2.0 mm. The comparative example 1 employed a narrow groove which does not have any inside concave curved surface and any outside concave curved surface, and the other examples than the comparative example 1 employed a narrow groove in which the inner surface of the groove bottom portion is formed by the single circular arc. In the comparative example 2, the relationship R≥W is not satisfied. In the example 4, the center point of the circular arc is positioned closer to the tread end side than the width center position of the narrow groove. Results of evaluation are shown in Table 1.

TABLE 1

| | Comparative | Working | Working | Working | Comparative | Working |
|---|---|---|---|---|---|---|
| | Example 1 | Example 1 | Example 2 | Example 3 | Example 2 | Example 4 |
| Width W (mm) | 2.0 | 2.0 | 2.0 | 2.0 | 2.0 | 2.0 |
| Radius R (mm) | — | 2.5 | 4.0 | 2.0 | 1.8 | 2.0 |
| Distance G (mm) | — | 0.0 | 2.0 | 0.2 | 1.0 | −1.0 |
| Groove bottom | 125 | 85 | 70 | 85 | 100 | 85 |
| crack resistance | | | | | | |
| Irregular wear | 1.20 | 1.10 | 1.00 | 1.05 | 1.15 | 1.15 |
| resistance | | | | | | |

From Table 1, it can be known that the working examples 1 to 4 can achieve the comparatively excellent groove bottom crack resistance and irregular wear resistance. Among them, the working examples 2 and 3 are particularly excellent in the irregular wear resistance. In the comparative examples 1 and 2, the groove bottom crack is remarkably generated in comparison with the working examples 1 to 4, and there is fear that the tear is generated from the groove bottom crack. As a result, the working examples 1 to 4 can be evaluated to be more excellent in the tear resistance than the comparative examples 1 and 2.

What is claimed is:

1. A pneumatic tire comprising:
a narrow groove which extends in a tire circumferential direction, with the narrow groove being formed in a shoulder land portion of a tread,
wherein an inside concave curved surface and an outside concave curved surface are formed in a groove bottom portion of the narrow groove, the inside concave curved surface being formed by depressing a groove wall in a tread center side, and the outside concave curved surface being formed by depressing a groove wall in a tread end side,
wherein an inner surface of the groove bottom portion including the inside concave curved surface and the outside concave curved surface is formed by a single circular arc in a tire meridian cross section, and
wherein a radius of curvature of the circular arc is equal to or larger than a width of an opening portion of the narrow groove.

2. The pneumatic tire according to claim 1, wherein the radius of curvature of the circular arc is larger than the width of the opening portion of the narrow groove.

3. The pneumatic tire according to claim 1, wherein a center point of the circular arc is positioned closer to the tread center side than a width center position of the narrow groove.

4. The pneumatic tire according to claim 3, wherein a distance from the center point of the circular arc to the width center position of the narrow groove is equal to or less than 0.5 times of the width of the opening portion of the narrow groove.

5. The pneumatic tire according to claim 1, wherein a depth getting to the groove bottom portion from a surface of the tread is equal to or larger than a depth of a main groove facing the shoulder land portion.
